(19) United States
(12) Patent Application Publication
(10) Pub. No.: US 2014/0006712 A1
(43) Pub. Date: Jan. 2, 2014

(54) SYSTEMS AND METHODS FOR FINE GRANULARITY MEMORY SPARING

(71) Applicants: Joseph A. Tucek, Palo Alto, CA (US); Eric A. Anderson, Palo Alto, CA (US); Mehul A. Shah, Saratoga, CA (US)

(72) Inventors: Joseph A. Tucek, Palo Alto, CA (US); Eric A. Anderson, Palo Alto, CA (US); Mehul A. Shah, Saratoga, CA (US)

(21) Appl. No.: 14/005,193

(22) PCT Filed: Mar. 16, 2011
(86) PCT No.: PCT/US11/28615

§ 371 Date: Sep. 13, 2013

(51) Int. Cl. G06F 12/10; G06F 12/08

(52) U.S. Cl. CPC G06F 12/10; G06F 12/08
USPC 711/118; 711/206

(57) ABSTRACT

Systems and methods for fine-grained sparing in non-volatile memories art disclosed. A system may include a memory having a plurality of blocks, a plurality of tags and a plurality of spared lines, wherein each of the tags corresponds to one of the plurality of spared lines, and table having a plurality of machine addresses, wherein each machine address corresponds to a sparing area for each of the blocks of the plurality of blocks. Methods of operation a fine-grained sparing system are also disclosed.

### BACKGROUND

This section is intended to introduce the reader to various aspects of art, which may be related to various aspects of the present invention that are described or claimed below. This discussion is believed to be helpful in providing the reader with background information to facilitate a better understanding of the various aspects of the present invention. Accordingly, it should be understood that these statements are to be read in this light, and not as admissions of prior art.

Computer systems are generally employed in numerous configurations to provide a variety of computing functions. For example, computer systems may include personal computer systems (e.g., desktop and laptop computers), as well as, commercial systems (e.g., servers or industrial computers). Each of these systems may rely on a plurality of components interacting to provide reliable computing power and bandwidth. For instance, computer systems may employ a combination of processors, memory, input/output devices, disk drives, power supplies, fans, and the like to operate effectively.

### BRIEF DESCRIPTION OF THE DRAWINGS

FIG. 1 is a block diagram of a processor-based system in accordance with an embodiment of the present invention;

FIG. 2 is a block diagram of a logical to physical address translation for a memory in accordance with an embodiment of the present invention;

FIG. 3 is a block diagram of a sparing table lookup in accordance with an embodiment of the present invention;

FIG. 4 is a block diagram of a sparing area in accordance with an embodiment of the present invention;

FIG. 5 is a block diagram of a sparing table lookup in accordance with another embodiment of the present invention;

FIG. 6 is a block diagram of a sparing area in accordance with an embodiment of the present invention;

FIG. 7 is a block diagram of a “bad” block in accordance with an embodiment of the present invention;

FIG. 8 is a block diagram of a sparing lookaside buffer in accordance with an embodiment of the present invention; and

FIG. 9 is a block diagram of a fine-grained sparing system in accordance with an embodiment of the present invention.

### DETAILED DESCRIPTION OF SPECIFIC EMBODIMENTS

One or more embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Various memory technologies may be used in a computer system, such as volatile and non-volatile memories. Some types of non-volatile memory may have defective areas when fabricated or may become defective after use. For example, such memories may have manufacturing defects or may have areas that wear-out or become detective over time. Such memories may include spare portions that may be used to replace the defective areas. Typically, the spare portions are provided at a “coarse” level and are permanently activated by blowing fuses. However, blowing fuses to remap the spare portions does not provide any flexibility. Alternatives to blowing fuses, such as “soft-fuses,” must rediscover the remapping of the spare portions every power cycle and are inappropriate for non-volatile memories.

Embodiments of the present invention include a fine-grained sparing system for non-volatile memories capable of fine-grained memory operations. The fine-grained sparing system includes a sparing table that only provides sparing data for those lines of a block which require sparing. In some embodiments, a sparing lookaside buffer is provided for the lookup of sparing information for a block. Additionally, some embodiments may include arrangement of sparing tag information in the sparing area of a block, or an arrangement of sparing tag information and spare lines in a defective (“bad”) block.

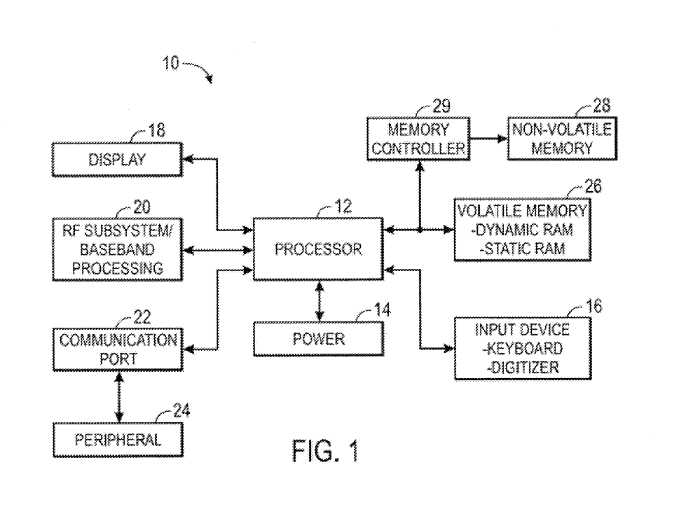

Turning now to the figures, FIG. 1 is a block diagram that depicts a processor-based system, generally designated by reference numeral 10. The system 10 may be any of a variety of types such as a computer, tablet computer, pager, cellular phone (e.g., a smartphone), personal organizer, control circuit, or the like. In a typical processor-based system, one or more processors 12, such as a microprocessor, control the processing of system functions and requests in the system 10.

The system 10 typically includes a number of components. For example, in the illustrated embodiment, the system 10 includes a power supply 14. If the system 10 is a portable system, the power supply 14 may advantageously include permanent batteries, replaceable batteries, and/or rechargeable batteries. The power supply 14 may also include an AC adapter, so the system 10 may be plugged into a wall outlet, for instance. The power supply 14 may also include a DC adapter such that the system 10 may be plugged into a vehicle cigarette lighter, for instance. Various other devices may be coupled to the processor 12 depending on the functions that the system 10 performs. In the illustrated embodiment, a user interface 16 is coupled to the processor 12. The user interface 16 may include buttons, switches, a keyboard, a light pen, a mouse, and/or a voice recognition system, for instance. A display 18 is coupled to the processor 12 in the illustrated embodiment. The display 18 may include an LCD display, a CRT, LEDs, and/or an audio display, for example. Furthermore, an RF sub-system/baseband processor 20 is coupled to the processor 12. The RF sub-system/baseband processor 20 may include an antenna that is coupled to an RF receiver and to an RF transmitter (not shown). Communication ports 22 are also be coupled to the processor 12. The communication port 22 may be adapted to be coupled to peripheral devices 24 such as a modem, a printer, a computer, or to a network, such as a local area network, remote area network, intranet, or the internet, for instance.

The processor 12 generally controls the system 10 by implementing software programs stored in the memory. The memory is operably coupled to the processor 12 to store and facilitate execution of various programs. For instance, the processor 12 may be coupled to a volatile memory 26 which may include Dynamic Random Access Memory (DRAM) and/or Static Random Access Memory (SRAM). The volatile memory 28 may store dynamically loaded applications and data.

The processor 12 may also be coupled to non-volatile memory 28 and may communicate with the non-volatile memory 28 through a memory controller 29. The memory controller 29 may be integrated with the processor 12 or may be a separate component. The non-volatile memory 28 may include phase change memory (PCM) and/or memristor memory. In other embodiments, the non-volatile memory 28 may include magnetoresistive memory (MRAM), ferroelectric memory (FeRAM), resistive memory (RRAM), FE Polymer Memory, Polymer memory, and spin torque transfer memory (STT-RAM). Additionally, the non-volatile memory 28 may include a read-only memory (ROM), such as an EPROM, and/or flash memory to be used in conjunction with the volatile memory. The size of the ROM is typically selected to be just large enough to store any operating system, application programs, and fixed data. Additionally, the non-volatile memory 28 may include a tape drive or hard disk drive.

The non-volatile memory 28 may be manufactured with extra storage, such as “spare” blocks, lines, etc., in the event some portions of the memory are or become unusable. Such a technique may be referred as “sparing,” and a spare block, group of spare lines, etc., may be referred to as a “sparing area.” In such memories, the spare portions of the memory 28 may be mapped to replace the defective portions, increasing effective manufacturing yields and/or the useful lifespan of the memory.

Some of the non-volatile memory 28, such as the PCM and memristor memory, may allow sparing at a fine level, e.g., at a line level, in contrast to sparing at a coarse level, e.g., at a block level. However, providing spare portions at a “coarse level” may result in sparing portions that are prohibitively large. As used herein, the farm block (also referred to as “page”) refers to a relatively large unit of memory, such as 4 kB. In some embodiments, a block may be larger than 4 kB or smaller than 4 kB, e.g., 512 kB, 256 kB, etc. As used herein, the term line (also referred to as a “row”) refers to a unit of memory smaller than a block and individually writeable and updateable. In some embodiments, a line may be 64 bytes, such as to match the width of a data bus from the processor 12. In other embodiments, a line may be smaller than 64 bytes, e.g., as small as 1 byte, or larger than 64 bytes, e.g., up to 1 kB. In some embodiments, the non-volatile memory 28 may be addressed at a sub-line. As used herein, the term “sub-line” refers to a unit smaller than a line and that can be separately addressed, although not necessarily independently writable. In some embodiments, a sub-line may be 1 kB.

Based on the above discussion, a memory address for the non-volatile memory 28 may include a block portion (also referred to as a “block address”), a line portion (also referred to as a “line address), and, in some embodiments, a sub-line portion (also referred to as a “sub-line address”), representing the digits in the address which select the respective block, line and sub-line. For illustrative purposes in the embodiments discussed below, an address may include a 26-bit address having a 10-bit block address, 6-bit line addresses, and 6-bit sub-line addresses. It should be appreciated that embodiments may include memories having a longer addressing scheme, i.e., greater than 26-bit, and having more blocks, lines, sub-lines, etc.

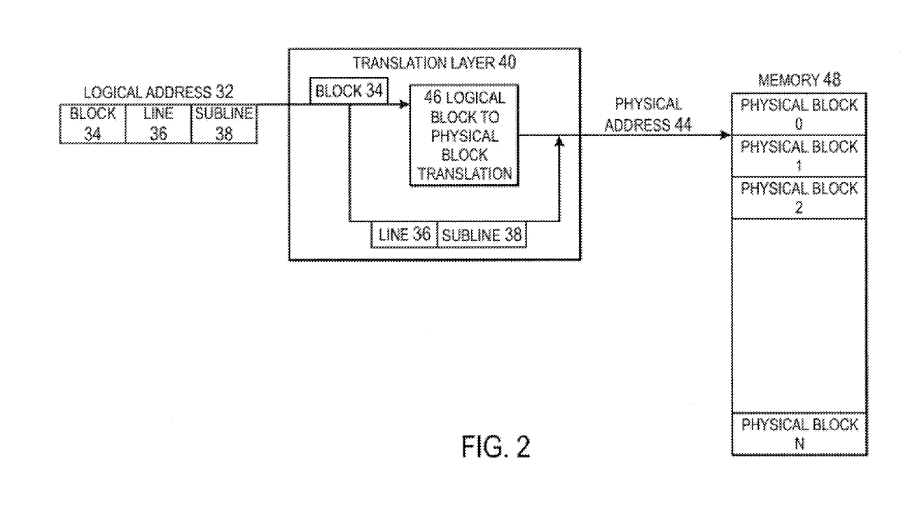

FIGS. 2-7 depict a fine-grained sparing system that spares at a fine level but also provides flexible remapping that uses less state than conventional table-based mapping. The sparing system described below may be particularly advantageous for non-volatile memories that allow fine-grained writes, such as the PCM and memristor memories discussed above. Some of the components of the fine-grained sparing system described below may be implemented in instructions stored on non-transitory tangible machine-readable media, and/or hardware. Such non-transitory tangible machine-readable media may be a part on the memory controller 29, and such hardware may be a part of the memory controller 29 or may be separate components.

FIG. 2 depicts an access scheme for non-volatile memory 23 in accordance with an embodiment of the present invention. A logical address 32 may be provided across a memory bus to the memory controller and may include a block portion 34, a line portion 36, and a sub-line portion 38. The memory controller may include a translation layer 40 that translates the logical address 32 to a physical address 44 corresponding to a particular location on the non-volatile memory 28. The translation layer 40 receives the logical address 32 and provides the physical address 44 for accessing the non-volatile memory 28, such as by specifying a block address, e.g., specifying block 0 to block n as shown in FIG. 2. In some embodiments, the translation layer 40 may translate the block portion 34 of the logical address 32 via logical-block-to-physical-block translation logic 46. In such an embodiment, the translation layer 34 may pass-through the other portions of the logical address 32, such as the line portion 36 and the sub-line portion 38.

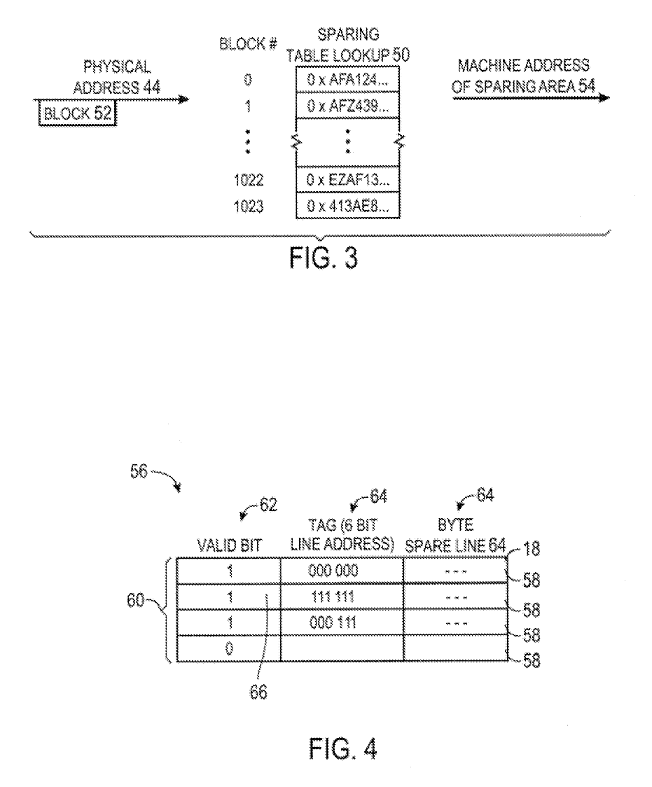

FIG. 3 depicts a sparing table lookup 50 in accordance with an embodiment of the present invention. As mentioned above, the sparing table lookup 50 may be stored on and may be a part of the memory controller 29. The sparing table lookup 50 translates a block address 52 of the physical address 44 to a machine address 54 of a sparing area. For example, as shown in FIG. 3, each block 0 to 1023 of a 1024 block memory may correspond to a row in the sparing table lookup 50. For each block determined from a physical address 44, the sparing table lookup 50 may include a corresponding machine address, e.g., 0xAFAD4 . . . , 0xAF2439 . . . , etc. The machine address 54 provides the machine address of the block of the sparing area for the physical address. As explained below, the spare line for the spared block may be determined from the sparing area itself.

FIG. 4 depicts an embodiment of a sparing area 56 in accordance with an embodiment of the present invention. The sparing area 56 includes four spare lines 58 in a block, although it should be appreciated that this is merely illustrative and other embodiments may include more or less spare lines in a block. The sparing area 56 may be stored in a physical block of the non-volatile memory 28 that is not used to store ordinary data (in some embodiments, however, the sparing area may be rotated according to wear leveling algorithms).

The four lines 58 of the sparing area 56 may be arranged in four rows 60. Each of the rows 60 may include a valid bit 62, a tag 64, and one of the spare lines 58. The valid bit 62 indicates if a line 58 of the sparing area 56 used, e.g., a “1” if the line is used and a “0” if the line is unused. The tag 64 indicates the line address to which the respective row corresponds. The spare line 58 is the replacement line for the line that is being spared. Thus, once a block of the physical address 44 is determined having been spared, such as in the spare lookup table 50 of FIG. 3, the line address of the physical address may be compared against the sparing area 56. If one of the tags 64 matches the line address of the physical address 44, the spare line 58 of that row is used for the memory operation instead of the original line specified in the physical address 44. Thus, the line identified by the physical address 44 may be referred to as a “spared line.”

As shown in FIG. 3, the block address 52 of the physical address 44 may be first matched in the sparing table lookup 50. Once the spared block for that block address is determined, the line address for the physical address 44 is compared against the sparing area 56 of FIG. 4. For example, if the line address of the physical address is 111111, this line address is compared to each row 60 of the sparing area 50 containing a valid bit 62 of “1”. As shown in FIG. 4, this physical address 111111 matches row 66, so the spare line 68 of row 66 will be used for the memory operation in place of the line at line address 111111.

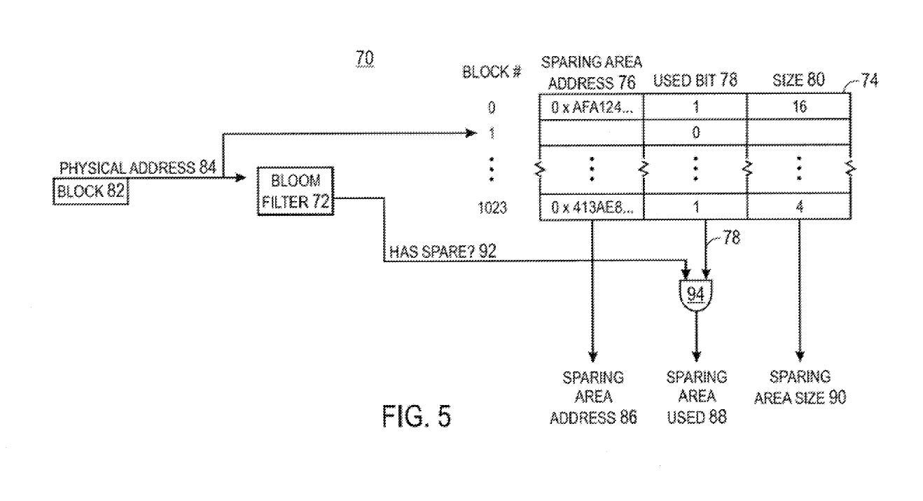

In other embodiments, more efficient sparing lookup logic may be used. FIG. 5 depicts a sparing table lookup 70 having a filter 72 in accordance with another embodiment of the present invention. As mentioned above, the sparing table lookup 70 may be stored on and may be a part of the memory controller 29 The sparing table lookup 70 may include the filter 72 to indicate if a block of a physical address does not need sparing and does not have a corresponding sparing area. The filter 72 thus prevents returning a sparing area address for every block received by the sparing table lookup 70. The sparing table lookup 70 may also include a modified sparing table 74 that provides additional information for the sparing lookup. As shown in FIG. 5, the sparing table 74 may include a sparing area address 76, a used bit 78, and a size 80.

As described above, the sparing area lookup 70 may include the sparing area address 76 that provides the machine address of a sparing area for a spared block, e.g., blocks 0 to 1023. The used bit 78 of the sparing area lookup 70 indicates if the sparing area is in use, such as by providing a “1” if the area is in use and a “0” if the area is unused. Finally, the size 80 of the sparing fable 74 provides the size of the sparing area at the sparing area address 76. The size 80 of the sparing table 74 allows for variable sized sparing areas and provides that information in the sparing area lookup 70.

With reference to FIG. 5, operation of the sparing area lookup 70 is described below. The sparing area lookup 70 translates a block portion 82 of a physical address 84 to a machine address 86. The sparing area lookup 70 also outputs a sparing area used indicator 88 and a sparing area size 90. The sparing area lookup 70 receives the block address 82 of the physical address 84 and first processes the block address 82 through the filter 72. In one embodiment, the filter 72 may be a bloom filter. The filter 72 may indicate if the block identified by the block address 82 has a sparing area or does not have a sparing area. The filter 72 may output a “has spare?” bit 92 as an indicator. As explained below, the “has spare?” bit may be provided to an AND gate 94. In other embodiments, the sparing data may be located in the logical-to-physical translation, such as the translation layer 40 of FIG. 2, so that the sparing information is provided simultaneously with the logical-to-physical translation.

The block address 82 may be provided to the sparing table 74, which translates the block address 82 to the machine address 76 of a sparing area. For example, as shown in FIG. 5, each block 0 to 1023 of a 1024 block memory may correspond to a row in the sparing table 74. For each block determined from the physical address 84, the sparing table 70 may include a corresponding machine address, such as 0xAFAD4, 0x413AE8, etc. The sparing table lookup 70 may output the machine address 86 of the sparing area. Additionally, as noted above, the sparing table 74 may also output the “used bit” indicating if the sparing area is used. The used bit may be input to the AND gate 94 with the “has spare?” bit 92 from the filter 72. The sparing table lookup 70 outputs the result of the AND gate 94 as the sparing area used indicator 88. The output from the AND gate 94 is a logical AND of the used bit indicator 88 and the “has spare?” bit 92. Thus, if the “has spare?” bit 92 and the used bit indicator” are both “1”, the sparing area used indicator 88 is “1”, indicating that the block is using a sparing area. Finally, as noted above, the sparing table lookup 70 also outputs the size 90 of the sparing area. In other embodiments, the size of the sparing area may be stored with the sparing area itself, rather than in the sparing fable 74.

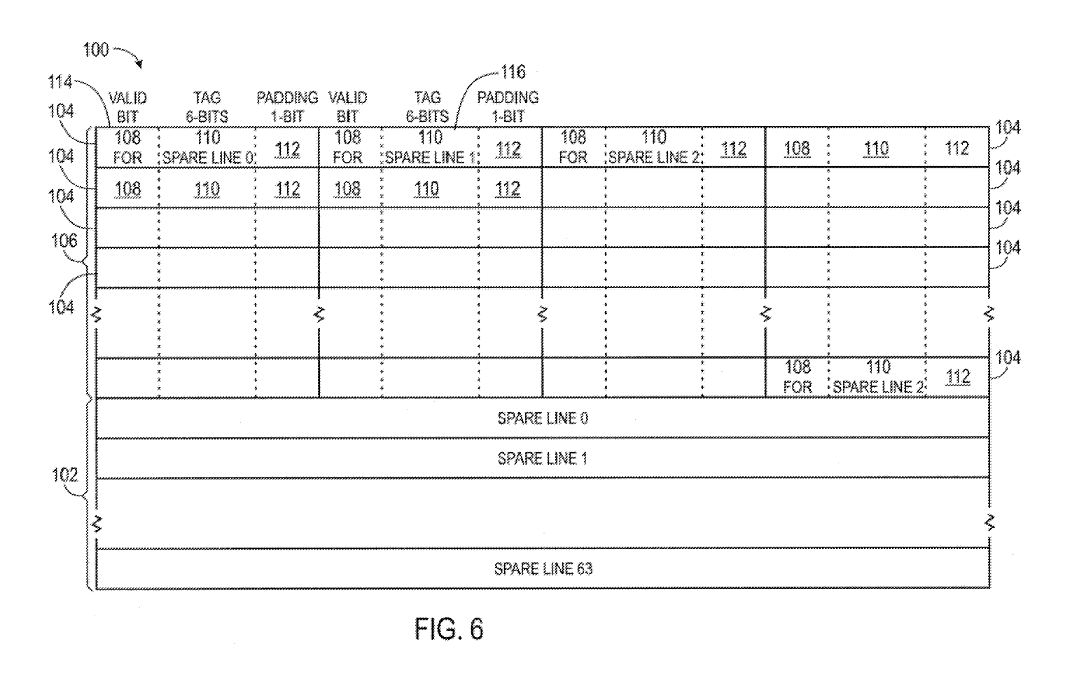

Some embodiments may include another physical arrangement of spare lines in a sparing area. FIG. 6 depicts a sparing area 100 in accordance with another embodiment of the present invention. The sparing area 100 includes spare lines 102 and tag and valid information 104 arranged in the sparing area 100. As will be explained below, the scale of the sparing area 100 is altered between the tag and valid information 104 and the spare lines 102 to better illustrate the arrangement of the sparing area 100.

The tag and valid information 104 depicted in FIG. 6 depicts 1 line 106, e.g., 64 bytes, of tag and valid information 104 arranged sequentially along the line. Each individual entry of the tag and valid information 104 may include a valid bit 108, a 6-bit tag 110, and a “padding” of 1 bit 112. Thus, in the embodiment shown in FIG. 6, each individual entry of the tag and valid information is 8 bits, i.e., 1 byte, allowing 64 individual entries of tag and valid information 104 to be contiguously stored in the 64 byte line 106. For example, a first entry 114 may store the tag and valid information for spare line 0. The first entry 114 may include the valid bit 108, the 6-bit tag 100 for the spare line 0, as well as the padding bit 112. As explained above, the 6-bit tag corresponds to the spared line that that is spared by spare line 0. In another example, the second entry 116 may store the tag and valid information for spare line 1. The second entry 116 may include the valid bit 108, the 6-bit tag 100 for the spare line 1, as well as the padding bit 112. In this manner, subsequent entries may include the tag and valid information for additional spare lines. Again, it should be appreciated that other embodiments may include lines having smaller or larger sizes and tag and valid information having smaller or larger sizes.

As shown in FIG. 6, the spare lines 102 may be contiguously arranged after the tag and valid information 104. Each spare line, e.g., spare line 0, spare line 1, etc., may be aligned on the line boundaries of the sparing area 100. In some embodiments, the spare lines 102 may have a variable sized or by arranged in a variable size sparing area. In such an embodiment, the size of the variable sized sparing area may be stored with the sparing area, such as the tag and valid information 104, as opposed to the sparing table 74 depicted in FIG. 5.

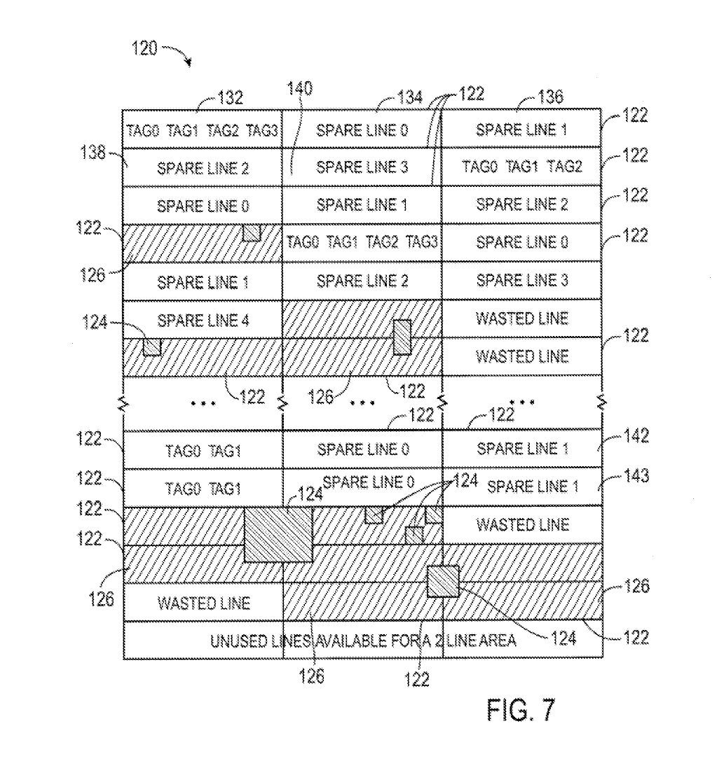

In some embodiments, the sparing area may be provided in an existing bad block. FIG. 7 depicts a bad block 120 used as a sparing area in accordance with an embodiment of the present invention. The bad block 120 is illustrated as having lines 122, e.g., 64-byte lines. The bad block 120 may include “bad” areas 124, e.g., damaged, defective, or otherwise unusable areas. The bad areas 124 may result in unusable lines 126, as any portion of a line with a bad area 124 may be unusable.

As shown in FIG. 7, tag information 128 and spare lines 130 may be arranged in the remaining “good,” e.g., usable areas of block 120. The tag information 120 may correspond to contiguous spare lines arranged immediately after the tag information 120. As shown in FIG. 7, a line 132 may include tag information corresponding to spare lines 134, 136, 138, and 140. For example, the tag information may include bits indicating “tag0tag1tag2tag3” that correspond to spare line 0, spare line 1, spare line 2, and spare line 3 respectively. Thus, each sparing area arranged in bad block 120 requires the use of at least two contiguous usable lines, one line for the tag information and one line for a spare line. For example, lines 142 and 144 that are not contiguous with any other usable lines may not be used as a sparing area.

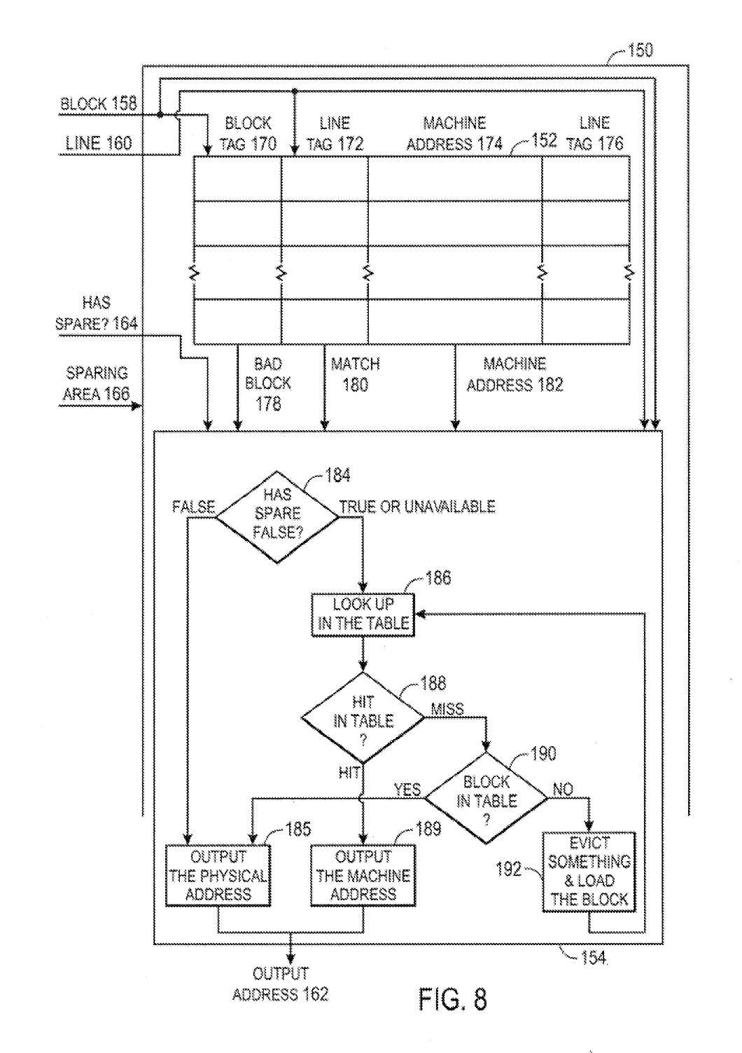

In some embodiments, a sparing cache may be used to provide a cache of which lines need sparing and the corresponding spare lines. FIG. 8 depicts a sparing lookaside buffer 150 in accordance with an embodiment of the present invention. As mentioned above, the sparing lookaside buffer 150 may be stored on and may be a part of the memory controller 29. The sparing lookaside buffer 150 may include a sparing cache table 152 and buffer logic 154. The sparing lookaside buffer 150 may receive a physical address 156 having a block address 158 and a line address 160 and may output an output address 162 of the sparing line for spared line. The sparing lookaside buffer 150 may also receive a “has spare?” bit 164, such as described above in FIG. 5, and a sparing area address 166.

The sparing cache table 152 may include a block tag 170, a line tag 172, a sparing area machine address 174, and a valid bit 176. The block tag 170 includes the addresses of spared blocks, the line tags 172 include the addresses of spared lines within a spared block, and the machine address 174 indicates the machine address of the spare line for the spared line. The valid bit 176 indicates if a row of the cache table 168 is valid and should be used. The cache table 168 outputs a bad block indicator 178 indicating a given block was found in the table and is spared, a line match indicator 180 indicating that a given line was found in the table and is spared, and the machine address 182 of the sparing area for a matched block and line. As described in detail below, the cache logic 154 receives the output from the cache table 152 and outputs the machine address 162.

The buffer logic 154 may receive the inputs to the buffer 150 and, based on the presences or absence of a spare line for the input line address 160, output the appropriate machine address for a given physical address. As shown in decision block 184, if the block 158 does not have a spared area, e.g., if “has spare?” is “0”, than the logic 154 outputs the physical line address and physical block address as the output address 162. As shown in decision block 186, if “has spare?” is “1” or there is no “has spare” bit available, the logic queries the cache table 152. As noted above, the cache table outputs a bad block indicator 178, a match indicator 180, and a machine address 182 of a spare line. As shown in decision block 188, if “has spare?” is “1” and there is a match returned from the cache table 152, then the output address 162 is the cached machine address 182 returned from the cached table 152. As shown in decision block 190, if “has spare?” is “1” and there is no match (referred to as a “miss”), and the bad block indicator is returned from the cache table, then the output address 162 is the physical line and physical block address, as the physical line for that block is not spared and did not have a spare line in the cached table 152.

As shown in decision block 192, if “has spare?” is “1” and there is no match returned from the cache table 152, and the bad block indicator 178 is also not retuned from the cache table 152, then the cache table 152 does not have sparing data for that block. In this case, the logic 154 may load the sparing data into the cache table 152, using the sparing area address 166 received from the sparing table. In some embodiments, the logic 154 may evict old entries from the cache table 152. Such an eviction may include eviction of an entire block's cached data from the cache table 152, avoiding the need to track how many of a block's spared lines are cached. The machine address 174 of the cache table 152 may be filled in with the machine address of the spare lines that correspond to the tags of the sparing area address 166. Once the loading of the cache table 152 is complete, the logic 154 may re-query the cache table 152 and proceed through the decision blocks 186, 188, and 190. If there is a subsequent “miss,” then the line 160 is not spared and the logic 154 outputs the physical block and physical line address as the output address 162.

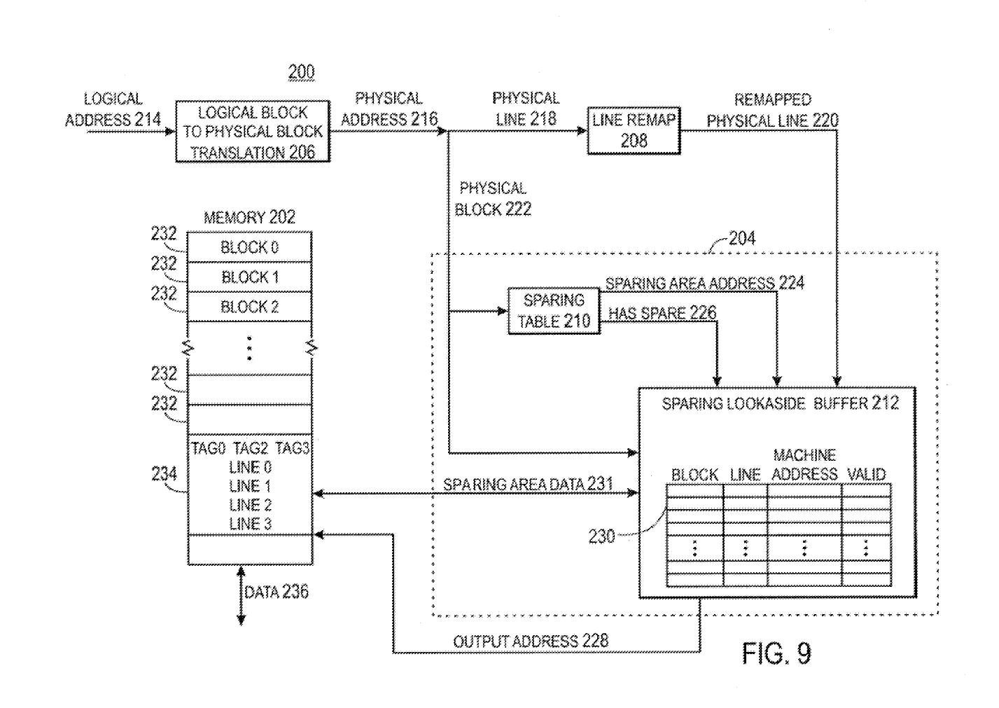

It should be appreciated that the fine grained sparing system and techniques described above may be integrated with other techniques, such as wear leveling and block-level sparing. FIG. 9 depicts a system 200 having a memory 202 and a fine grained sparing system 204, logical-to-physical address translation 206, and a line remap 208 in accordance with an embodiment of the present invention. The sparing system 204 may include a sparing table 210 and a sparing lookaside buffer 212 that operate according to the embodiments described above in FIGS. 3, 5, and 8. It should be appreciated that the various components of the system 200 may be implemented in instructions stored on a non-transitory tangible machine-readable media (e.g., a memory), hardware, or any combination thereof.

As shown in FIG. 9, the system 200 may receive a logical address 214 that is translated to a physical address 216, such as described above in FIG. 2. The line portion 218 of the physical address 216 may be provided to the line remap 208. The line remap 208 may remap the line portion 218 of the physical address 216 to a remapped physical line address 220. The block portion 222 of the physical address 216 may be provided to the sparing table 210 and the sparing lookaside buffer 212. As described above in FIG. 5, the sparing table 210 may output a sparing area address 224 and “has spare?” bit 226.

The sparing lookaside buffer 212 may receive the remapped physical line address 220 from the line remap 208, the physical block address 216, and the sparing area address 224 and “has spare?” bit 226. As described above in FIG. 8, the sparing lookaside buffer 212 may provide an output address 228. Based on the logic described above, the output address 228 may be the physical block address 222 and the remapped line address 220, or the output address 228 may be the machine address of a spare line read from a cache table 230. As also described above, the sparing lookaside buffer 212 may fetch sparing area data 231, e.g. tags, from the memory 202 and load this data in the cache table 230.

As described above, the memory 202 may be arranged in blocks 232 and may include sparing areas 234, such as described above in FIGS. 6 and 7. The sparing areas 234 may include tags indicating the spare lines, and the tags may be provided to the sparing lookaside buffer 212. The memory 202 may respond to a memory operation, e.g., read, write, erase, at the output address received from the sparing lookaside buffer 212, and input or output data 236.

Advantageously, embodiments of the line-grained sparing system described above reduce the state required to track spare lines to be proportional to the number of defective lines and the number of lines, rather than the total number of lines of a memory. Further, the number of spare lines in a memory is not fixed at the time of manufacturing and may be modified over the lifespan of the memory. Finally, sparing areas and corresponding tags may be stored in defective blocks that are otherwise unusable.

What is claimed is:

1. A system, comprising:
a memory, comprising a plurality of blocks, a plurality of tags and a plurality of spared lines, wherein each of the tags corresponds to one of the plurality of spared lines; and
a first fable comprising a plurality of machine addresses, wherein each machine address corresponds to a one of a plurality of sparing areas for a respective one of the plurality of blocks.

2. The system of claim 1, comprising an address translator that translates a logical memory address to a physical machine address.

3. The system of claim 1, wherein a first group of the plurality of tags are stored on a first contiguous portion of a first block of the plurality of blacks and a first group of the plurality of spared lines are stored on a second contiguous portion of the block of the memory.

4. The system of claim 1, wherein the first table comprises a plurality of sizes indicating the size of a respective one of a plurality of sparing areas for a respective one of the plurality of blocks.

5. The system of claim 1, comprising a bloom filter that determines if a block of the plurality of blocks has a sparing area.

6. The system of claim 1, comprising a sparing cache that stores a portion of the plurality of tags and a portion of the plurality of machine addresses.

7. The system of claim 1, wherein the memory comprises phase change memory or memristor memory.

8. A method comprising:
receiving a physical memory address comprising a block address and a line address for a memory of a processor-based system;
determining a sparing area for the block address of the physical memory address;
determining if the line address of the physical memory address has a spare line in the sparing area; and
providing an output address based on the determination of the spare line.

9. The method of claim 8, wherein determining a sparing area for a block address of the physical memory address comprises retrieving a machine address for the sparing area from a sparing table.

10. The method of claim 8, wherein determining the sparing area for a block address of the physical memory address comprises providing the block address to a bloom filter.

11. The method of claim 8, comprising determining the size of the sparing area.

12. The method of claim 8, comprising determining the machine address of the spare line.

13. The method of claim 8, wherein the output address comprises the line address of the physical memory address.

14. The method of claim 8, wherein the output address comprises a machine address of the spare line.

15. A method, comprising:
receiving a physical address comprising a block and a line of a memory of a processor-based system;
determining if the block of the physical address has a sparing area;
comparing the line of the physical address to a cache; and
outputting an output address based on the comparison.

16. The method of claim 15, wherein determining if the block of the physical address has a sparing area comprises comparing the block of the physical address to the cache.

17. The method of claim 15, wherein the cache comprises a block tag, a line tag, and a machine address of a spare line.

18. The method of claim 15, wherein outputting an output address comprises outputting the block and line of the physical address if the block does not have a sparing area.

19. The method of claim 17, wherein outputting an output address comprises outputting the machine address of the spare line if the block has a sparing area.

20. The method of claim 17, comprising evicting the block tag, line tag, and machine address from the cache and loading a second block tag, second line tag, and second machine address into the cache.
